(19) United States
(12) Patent Application Publication
(10) Pub. No.: US 2012/0075987 A1
(43) Pub. Date: Mar. 29, 2012

(54) RADIO APPARATUS, METHOD FOR COMMUNICATION DISTURBANCE REMEDIAL ACTION AND PROGRAM FOR COMMUNICATION DISTURBANCE REMEDIAL ACTION

(76) Inventors: Seijiro YONEYAMA, Yokohama-shi (JP); Akira Ichie, Saitama-shi (JP)

(21) Appl. No.: 13/073,262

(22) Filed: Mar. 28, 2011

(30) Foreign Application Priority Data
Sep. 27, 2010 (JP) 2010-215913

(51) Int. Cl. H04W 24/04

(52) U.S. Cl. 370/216

(57) ABSTRACT

A radio apparatus configured to identify a fault of a radio link with a radio station and to execute a remedial action has a statistical information acquisition part configured to acquire a characteristic value of statistical information expressing a status of the radio link, a fault detector configured to detect a plurality of faults preliminarily associated with the statistical information in a predetermined order based on the characteristic value, and a remedial action execution part configured to execute a remedial action preliminarily associated with the fault detected by the fault detector, wherein the plurality of faults comprises a shadowing and a radio noise, and the predetermined order is set so that a detection of the shadowing has priority over a detection of the radio noise.

### CROSS REFERENCE TO RELATED APPLICATIONS

This application is based upon and claims the benefit of priority from the prior Japanese Patent Applications No. 2010-215913, filed on Sep. 27, 2010, the entire contents of which are incorporated herein by reference.

### FIELD

The present embodiment relates to a radio apparatus that performs radio communications with another radio station and a method for communication disturbance remedial action and a program for communication disturbance remedial action.

### BACKGROUND

It is a known technique to combine and observe statistical information having correlations with communication disturbances, and estimate the type of communication disturbance based on the pattern of change in the combined statistical information.

However, the communication disturbances and statistical information may not necessarily have one-to-one correspondence. It is thus possible to perform estimation of high accuracy when a single communication disturbance occurs independently. Estimation accuracy, however, gets worse when a plurality of types of communication disturbances occur together.

### BRIEF DESCRIPTION OF THE DRAWINGS

FIG. 1 is a block diagram showing a schematic configuration of a radio communication system having a radio apparatus according to a first embodiment;

FIG. 2 is a block diagram showing an example of the internal structure of a radio apparatus M;

FIG. 3 is a view showing a state in which shadowing is occurring;

FIG. 4 is a view showing a state in which interference is occurring because of a radio noise;

FIG. 5 is a flowchart indicating an example of the procedure of a statistical information acquisition part 11 according to the first embodiment;

FIG. 6 is a flowchart indicating an example of the procedures of a fault detection part 13 and a remedial action execution part 14 according to the first embodiment;

FIG. 7(a) is a view showing patterns of fault occurrence and FIG. 7(b) a view showing the relationship between the patterns of fault occurrence and characteristic values of statistical information;

FIG. 8 is a view showing a state in which duplicate frames increase;

FIG. 9 is a view showing a state in which multipath fading occurs;

FIG. 10 is a view showing a state in which radio terminals B1 and B2 are connected to a radio base station A, thus causing congestion;

FIG. 11 is a view showing a state in which the radio terminals B1 and B2 become a hidden terminal with respect to each other;

FIG. 12 is a flowchart indicating an example of the procedures of a fault detection part 13 and a remedial action execution part 14 according to a second embodiment;

FIG. 13A is a view showing examples of the relationship between statistical information and faults, and the procedures of fault estimation and remedial action;

FIG. 13B is a view showing examples following to FIG. 13A;

FIG. 14 is a block diagram showing an example of the internal structure of a radio apparatus M according to a third embodiment;

FIG. 15 is a view showing examples of traffic parameters included in a traffic request; and

FIG. 16 is a view showing parameters of a radio frame to be transmitted by a radio base station.

### DETAILED DESCRIPTION

Embodiments will now be explained with reference to the accompanying drawings.

A radio apparatus configured to identify a fault of a radio link with a radio station and to execute a remedial action has a statistical information acquisition part configured to acquire a characteristic value of statistical information expressing a status of the radio link, a fault detector configured to detect a plurality of faults preliminarily associated with the statistical information in a predetermined order based on the characteristic value, and a remedial action execution part configured to execute a remedial action preliminarily associated with the fault detected by the fault detector, wherein the plurality of faults comprises a shadowing and a radio noise, and the predetermined order is set so that a detection of the shadowing has priority over a detection of the radio noise.

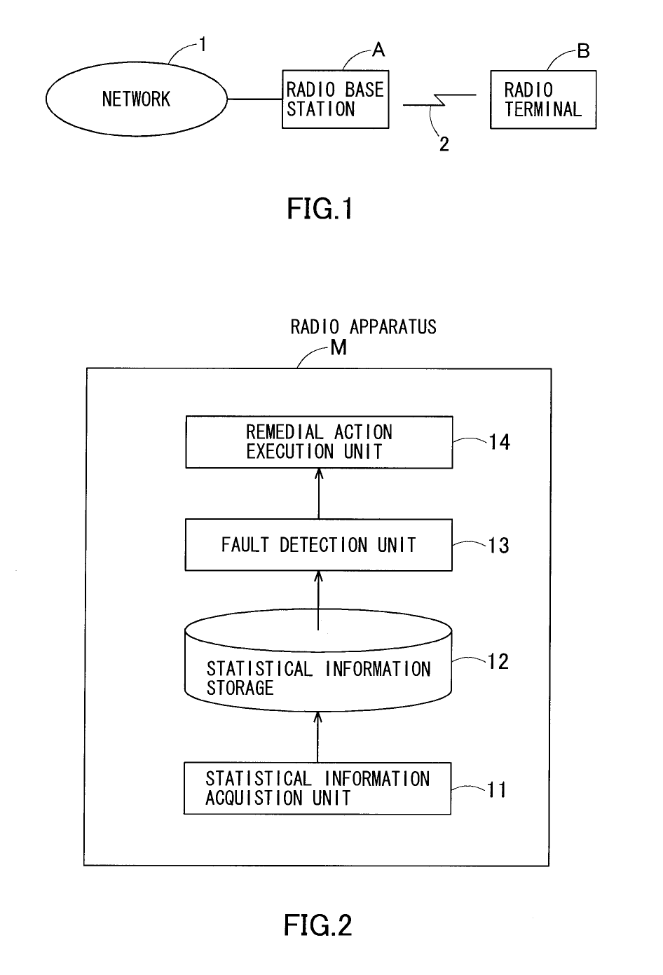

FIG. 1 is a block diagram showing a schematic configuration of a radio communication system having a radio apparatus according to a first embodiment.

In FIG. 1, a reference sign 1 denotes a network and a reference sign “A” denotes a radio base station connected to the network 1. A reference sign 2 denotes a radio link and a reference sign “B” denotes a radio terminal connected to the radio link 2. FIG. 1 shows only one radio terminal B connected to the radio base station A. However, a plurality of radio terminals may be connected to the radio base station A. The radio link is a wireless LAN, for example. However, it may not be necessarily a wireless LAN, but may be a radio communications system based on CSMA/CA (Carrier Sense Multiple Access with Collision Avoidance), for example.

In FIG. 1, either of the radio base station A and the radio terminal B is a radio apparatus M according to a first embodiment and the other is another radio station.

FIG. 2 is a block diagram showing an example of the internal structure of the radio apparatus M. The radio apparatus M of FIG. 2 has a statistical information acquisition part 11, a statistical information storage 12, a fault detection part 13, and a remedial action execution part 14.

The statistical information acquisition part 11 acquires characteristic values of the statistical information indicating a status of the radio link. The statistical information storage 12 stores the characteristic values of the statistical information acquired by the statistical information acquisition part 11, together with time information. The fault detection part 13 detects faults in a specific order based on the characteristic value of the statistical information stored in the statistical information storage 12, the faults being preliminarily related to the statistical information 12. The remedial action execution part 14 performs the remedial actions preliminarily related to the faults detected by the fault detection part 13.

An example in which the radio apparatus M is installed in the radio terminal B will be explained below. However, as described above, the radio apparatus M can also be installed in the radio base station A.

Examples of statistical information and faults used in this embodiment will be explained at first hereinafter.

### <Examples of Statistical Information>

(1) Received Signal Strength

(2) Noise Level or Channel Load

The received signal strength in (1) is an indicator indicating the quality of a received signal. For example, RSSI (Received Signal Strength Identifier) is used as one example of the indicator. There is a characteristic in which when an obstacle, such as a wall, exists between the radio base station A and the radio terminal B, a direct wave is attenuated, and hence communication due to a diffracted wave or a reflected wave is performed, thereby lowering received signal strength.

The noise level in (2) is an indicator indicating the strength of an interference signal generated in a radio wave propagation channel, a thermal noise generated in a signal receiving circuit of a radio apparatus, etc. For example, Noise Histogram defined in IEEE802.11k standard corresponds to this indicator. There is a characteristic in which the noise level increases by the signal power of the other standard such as a microwave oven and Bluetooth, and also increases by a radio signal received at a low reception level lower than a carrier-sense detection threshold level even if the radio signal complies with IEEE802.11 standard.

There is a channel load as statistical information available instead of the noise level. The channel load is an indicator indicating a ratio of a time determined to be a busy state by a radio apparatus through carrier sense. For example, Channel Load defined in IEEE802.11k standard corresponds to this indicator. The channel load increases when a radio wave transmitted by another radio apparatus is detected. The channel load also increases when a radio wave of a microwave oven, Bluetooth, etc. in the other standards is detected.

### <Examples of Faults>

(1) Shadowing

(2) Radio Noise

Shadowing in (1) indicates a state in which the radio base station A and the radio terminal B are physically separated from each other and hence the attenuation of a radio signal is high. Or, it indicates a state in which an obstacle, such as a wall, exists between the radio base station A and the radio terminal B and hence a direct wave is blocked, thus communication is carried out with a diffracted wave or a reflected wave.

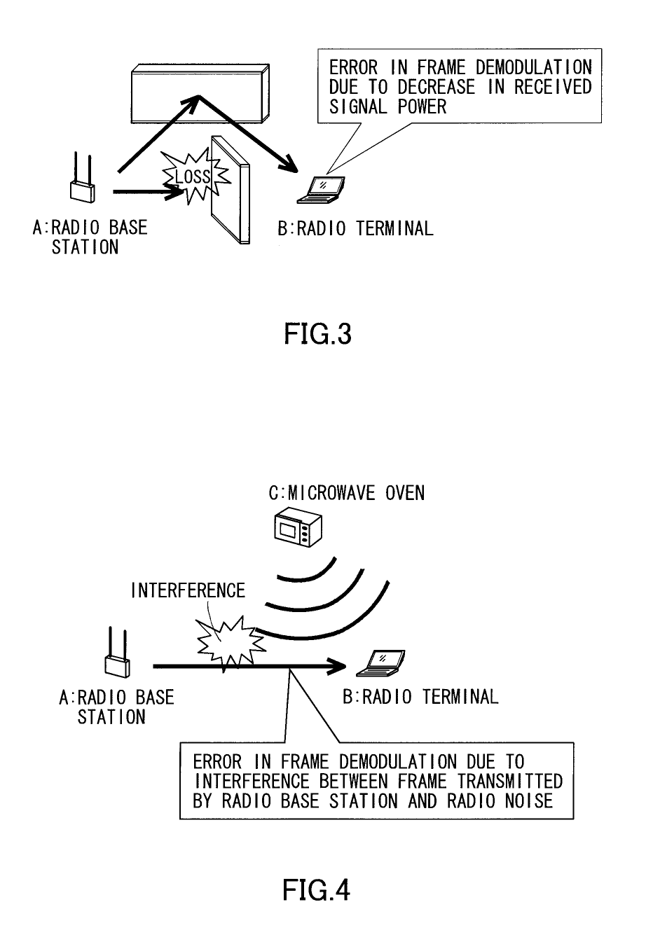

FIG. 3 is a view showing a state in which shadowing occurs. When shadowing occurs, a received signal power of a frame received by the radio terminal B becomes weaker and hence the probability of errors in a frame demodulation procedure becomes higher. It is characteristic of shadowing, for example, to lower the received signal strength, to increase the noise level due to the reception of a radio signal at a low reception level, and to increase the channel load due to frequent occurrence of frame retransmission, as shown in the examples of statistical information.

The radio noise in (2) indicates a state in which a radio wave interferes with another radio wave of a microwave oven, Bluetooth [TM], etc. in the same frequency band under a standard different from IEEE802.11 standard.

FIG. 4 is a view showing a state in which interference occurs due to a radio noise (a microwave oven C). When a radio noise is generated, interference occurs between a frame transmitted from the radio base station A to the radio terminal B and the radio noise. There is a characteristic in which the noise level and channel load increase, as shown in the examples of statistical information.

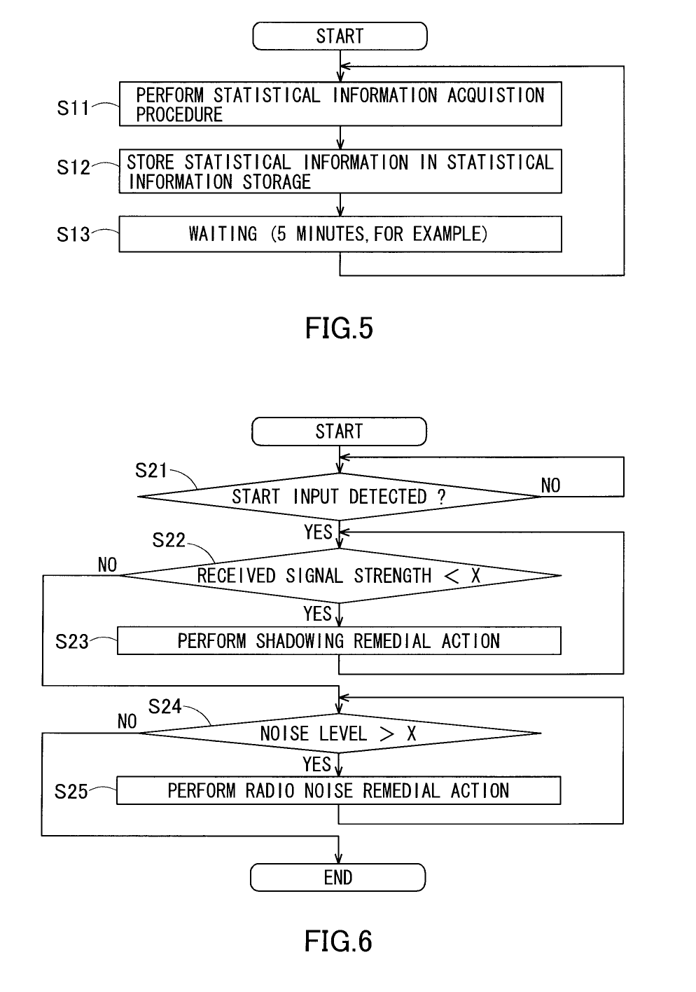

FIG. 5 is a flowchart indicating an example of the procedure of the statistical information acquisition part 11 according to the first embodiment. First, the statistical information acquisition part 11 performs the processing of acquiring predetermined statistical information (step S11). Next, the statistical information acquired by the statistical information acquisition part 11 is stored in the statistical information storage 12, together with time information (step S12). In order to periodically perform the acquisition of statistical information, the procedure is returned to step S11 after a predetermined waiting time (step S13).

Here, the periodic interval is generally five minutes, for example, in a statistical acquisition tool on the Internet. It is also possible to acquire all statistical information shown in the examples of statistical information at the same periodic interval. Moreover, a periodic interval may be set for each piece of statistical information to be acquired. Furthermore, for the statistical information that varies in a short time, the mean value, the maximum value, the minimum value, the standard deviation, etc. may be calculated and stored in the statistical information storage 12.

FIG. 6 shows an example of the procedures of the fault detection part 13 and the remedial action execution part 14. First, the fault detection part 13 detects a start input of the procedure (step S21). The start input may be periodic input of a trigger signal from a periodic timer or the like. Or, a hardware switch (a button) may, for example, be installed in the radio terminal B. Then, when a user presses the button as desired, the pressed button may be detected as the start input. In the former, the start input is periodically given to the fault detection part 13. Therefore, it is possible to periodically monitor the condition of fault occurrence. On the contrary, in the latter, an instruction from a user is given as the start input. Therefore, the user can detect a fault on demand and in real time.

Next, after the start input is detected, the fault detection part 13 acquires the received signal strength shown in the examples of statistical information from the statistical information storage 12 and determines whether shadowing occurs (step S22). The criterion is, for example, whether the received signal strength is below a preset threshold value (such as, −80 dBm). When the received signal strength is below the threshold value, it is determined that shadowing occurs.

When the fault detection part 13 determines that shadowing occurs, the remedial action execution part 14 performs a preset remedial action procedure to eliminate shadowing (step S23). The remedial action procedure may be any particular procedure as long as it can recover the received signal strength. For example, it may be a technique for using Transmit Power Control defined in IEEE802.11 standard to increase the transmission power of both of the radio base station A and the radio terminal B. As for the remedial action procedure against shadowing, a manual technique such as moving the radio base station A and the radio terminal B physically close to each other or moving to a position with no blockage such as a wall, to recover the received signal strength, is also effective. Therefore, it is possible to adopt a countermeasure such as installing a display apparatus in the radio terminal B and displaying a detailed remedial action procedure thereon in order to advise user to execute the remedial action procedure.

After the remedial action execution part 14 performs the remedial action procedure, the fault detection part 13 determines again whether there is shadowing. The remedial action execution part 14 repeatedly performs the remedial action procedure until the fault detection part 13 determines that shadowing does not occur any more.

As the repeated remedial action procedure, the procedure may be switched to another remedial action procedure depending on the repetition. In this case, there is a countermeasure, for example, in which the transmission power is first increased by Transmit Power Control and then the shift of a physical position of the radio terminal B is instructed to a user.

Or, as the repeated countermeasure, the degree of the effectiveness of remedial action may be changed for re-execution even if the remedial action procedure is the same. In this case, there is a countermeasure in which the transmission power is increased step by step by Transmit Power Control or a countermeasure in which a physical position of the radio terminal B for instructing user is shifted step by step.

When the fault detection part 13 determines that shadowing does not occur, it acquires the noise level shown in the example of statistical information from the statistical information storage 12 and determines that a radio noise occurs (step S24). The criterion is, for example, whether a noise level exceeds a preset threshold level (such as, −70 dBm). When the noise level exceeds the threshold level, it is determined that the radio nose occurs. Instead of the noise level, the channel load shown in the example of statistical information may be used as the criterion. The criterion is, for example, whether the channel load exceeds a preset threshold value (such as, 50%). When the channel load exceeds the threshold value, it is determined that a radio noise occurs.

When the fault detection part 13 determines that a radio noise occurs, the remedial action execution part 14 performs a preset remedial action procedure to remove the radio noise (step S25). As a procedure against the radio noise, it is effective to take a manual countermeasure such as moving the radio base station A and the radio terminal B physically close to each other, moving the radio terminal B to the position where a radio noise cannot reach, removing a source of generating a radio noise, etc. Therefore, it may be possible to adopt a countermeasure such as installing a display apparatus in the radio terminal B and displaying a detailed remedial action procedure thereon in order to advise user to execute the remedial action procedure.

After the remedial action execution part 14 performed the remedial action procedure, the fault detection part 13 determines again whether there is a radio noise. The remedial action execution part 14 repeatedly performs the remedial action procedure until the fault detection part 13 determines that a radio noise does not occur. The remedial action procedure to be repeated may be switched to another remedial action procedure depending on the repetition. In this case, there is, for example, a countermeasure in which user is instructed to remove a source of a radio noise, and then user is instructed to shift a physical position of the radio terminal B. Or, the degree of the effectiveness of remedial action may be changed for re-execution even if the remedial action procedure is the same. In this case, there is, for example, a countermeasure in which the physical position of the radio terminal B for instructing user is shifted step by step.

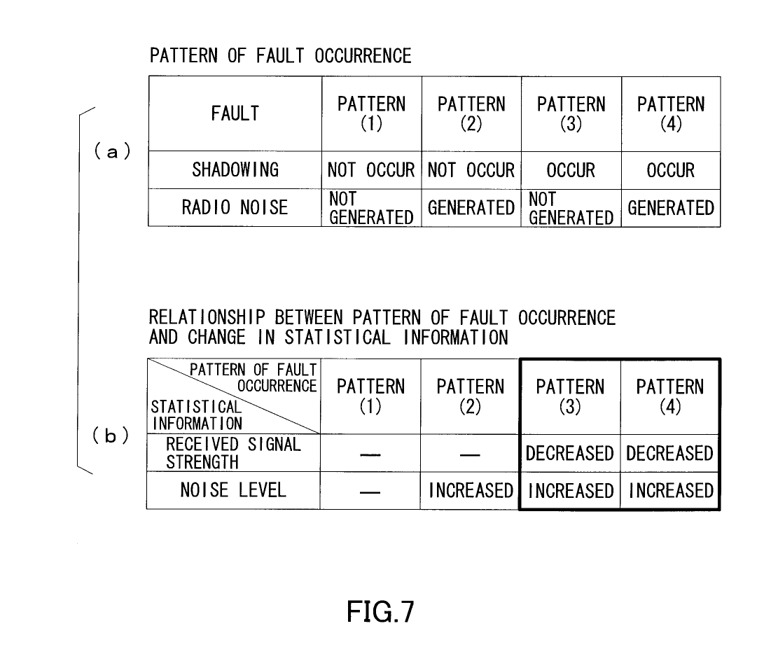

FIG. 7 is a view showing the relationship between statistical information and faults. FIG. 7(a) shows patterns of fault occurrence. FIG. 7(b) shows the relationship between the patterns of fault occurrence and characteristic values of statistical information. FIG. 7(a) shows only two types of fault that are shadowing and radio noise. FIG. 7(b) shows only two types of statistical information that are received signal strength and noise level. Moreover, FIG. 7(b) shows “weak” indicating that a received signal strength is weak and “-” indicating that a received signal strength is not varying, the two types of the characteristic values of statistical information for the received signal strength, and “increased” indicating that a noise level is increased and “-” indicating that a noise level is not varying, the two types of the characteristic values of statistical information for the noise level.

In FIG. 7(a), a pattern 1 is a state in which a fault does not occur, patterns 2 and 3 are a state in which either of the faults occurs, and a pattern 4 is a state in which both faults occur.

As understood from FIG. 7(b), a received signal strength decreases when shadowing occurs (the patterns 3 and 4) and a noise level increases when shadowing or a radio noise occurs (the patterns 2 to 4).

In accordance with the known technique, it can be estimated that a radio noise occurs in the case of the pattern 2 in which a noise level only increases. However, when the decrease in received signal strength and the increase in noise level occur at the same time (the patterns 2 and 3), it cannot be distinguished whether shadowing or a radio noise occurs.

Because of this, it may not be possible to estimate which type of fault occurs. Therefore, in order to take the remedial action for fault, it is required to take the remedial actions against both of shadowing and radio noise or take the remedial actions by try and error while measuring effectiveness. However, in the former, in the case of the pattern 3 in which only the shadowing occurs, unnecessary radio noise remedial action is taken, thereby wasting unnecessary cost. In the latter, the number of steps of operations in try and error increases, and hence it may take a long time for the operations.

The fault estimation method described in this embodiment is advantageous in that the estimation of faults in all of the four patterns 1 to 4 is possible and the minimum necessary remedial actions can be taken in the minimum steps. Moreover, the fault estimation method described in this embodiment is particularly effective under the restriction in that the statistical information capable of being acquired and used by a general-purpose radio apparatus M is limited. In general, when usable statistical information is little, faults that can be estimated are also few. Under this restriction, the range of faults that can be estimated can be spread by implementing determination of faults and remedial actions against faults in a specific order.

In more detail, in the first embodiment, a shadowing remedial action is taken at first, in consideration of one-to-one correspondence between the received signal strength and shadowing. When the problem of shadowing is solved, a radio-noise remedial action is taken next, in consideration of one-to-one correspondence between the noise level and radio noise. Accordingly, the remedial actions against shadowing and radio noise can be successfully taken with the minimum steps even when both faults occur together.

Furthermore, in this embodiment, the remedial actions against shadowing and radio noise can be taken only with the detection of received signal strength and noise level. Expensive measuring equipment is thus not necessary, so that hardware cost can be reduced. Especially, the detection of received signal strength and noise level can be achieved with the standard functions installed in a general-purpose radio apparatus. Improvements in the radio apparatus are thus also not necessary, so that the remedial actions against shadowing and radio noise can be easily taken.

The patterns of fault occurrence are not necessarily limited to the four types shown in FIG. 7(a). The faults are also not necessarily limited to the two types shown in FIG. 7(a). Moreover, the statistical information is not necessarily limited to the two types shown in FIG. 7(b). The characteristic values of the statistical information are also not necessarily limited to the values shown in FIG. 7(b). In a second embodiment which will be described below, an explanation is given about an example in which the number of statistical information and the number of faults are increased from those in the first embodiment.

### Second Embodiment

A radio communication system according to the second embodiment has the same configuration as that of FIG. 1. The internal structure of a radio apparatus M that is either a radio base station A or a radio terminal B is also the same as that of FIG. 2. In the following, an explanation is given to the points different from the first embodiment.

Described first are examples of statistical information and faults used in the second embodiment.

### <Examples of Statistical Information>

(1) Received Signal Strength

(2) Noise Level

(3) Reception Frequency of Duplicate Frames

(4) Channel Load

(5) Retransmission Frequency

The received signal strength, noise level, and channel load in (1), (2), and (4), respectively, were already explained in the first embodiment, and hence the detailed explanation thereof is omitted.

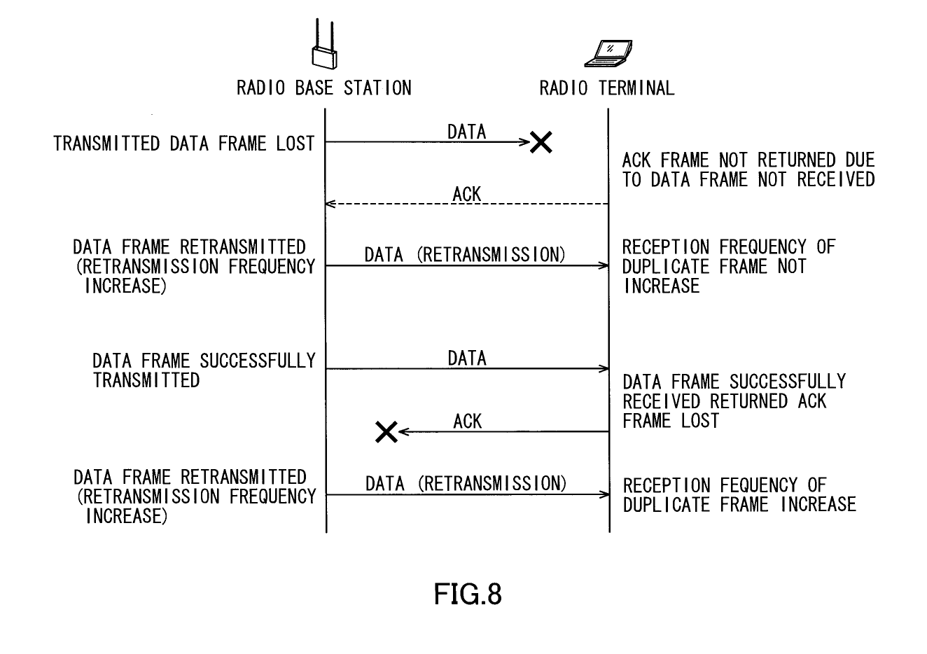

The reception frequency of duplicate frames in (3) refers to the frequency (ratio) of receiving again a data frame already received. The reception frequency is calculated based on Frame Duplicate Count defined in IEEE802.11 standard. FIG. 8 shows a state in which duplicate frames increase. A frame determined to be a duplicate frame is a frame which has already been received. That is, a frame that is retransmitted when a DATA frame is lost is not determined as a duplicate frame, whereas a frame that is retransmitted when an ACK frame is lost is determined as a duplicate frame. In this way, by observing the reception of duplicate frames, it is possible to determine a state in which a DATA frame arrives normally but an ACK frame is lost. Furthermore, by observing the reception of duplicate frames and the retransmission of frames, it is possible to determine a state in which an ACK frame arrives normally but a DATA frame is lost.

The retransmission frequency in (5) refers to the frequency (ratio) of not receiving an ACK frame from a sender, although a radio apparatus has transmitted a frame. The retransmission frequency is calculated, for example, based on Retry Count defined in IEEE802.11 standard. The retransmission frequency is characteristic in that it increases when a DATA frame is lost, and it also increases when an ACK frame is lost, even though a DATA frame arrives normally.

### <Examples of Faults>

(1) Shadowing

(2) Radio Noise

(3) Multipath Fading

(4) Congestion

(5) Hidden Terminal

Shadowing and radio noise in (1) and (2), respectively, were already explained in the first embodiment, and hence the detailed explanation thereof is omitted.

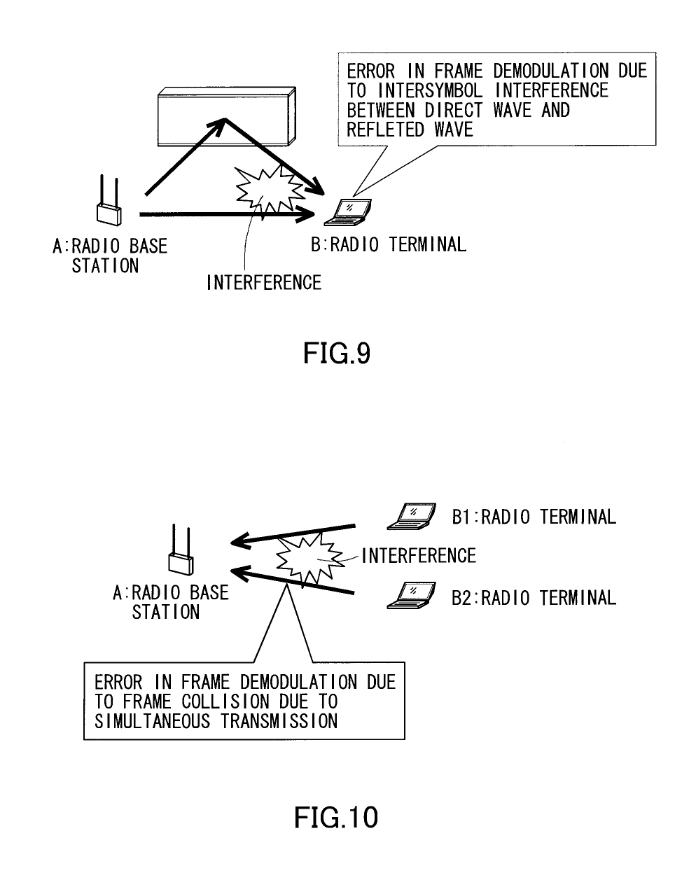

Multipath fading in (3) indicates a state in which, in addition to a direct wave, a reflected wave reflected by a wall or the like arrives later. FIG. 9 is a view showing a state in which multipath fading occurs. When multipath fading occurs, intersymbol interference occurs between a direct wave transmitted by the radio base station A and a reflected wave that arrives later. Multipath fading is characteristic in that the retransmission frequency shown in the examples of statistical information increases and also the reception frequency of duplicate frames increases because both of DATA and ACK frames are lost.

FIG. 9 shows a state in which a DATA frame transmitted from the radio base station A is lost before reaching the radio terminal B, so that the radio terminal B does not return an ACK frame, and hence the radio base station A retransmits the DATA frame. FIG. 9 also shows a state in which an ACK frame transmitted by the radio terminal B is lost before reaching the base station A, and hence the radio base station A retransmits a DATA frame.

Congestion in (4) indicates a state in which there are many radio terminals B belonging to a given channel, so that collision avoidance by CSMA/CA occurs frequently between all of the base stations and the radio terminals B belonging to the channel. FIG. 10 is a view showing a state in which radio terminals B1 and B2 are connected to the radio base station A, thus causing congestion. When congestion occurs, collision avoidance by CSMA/CA fails, thus increasing the probability of occurrence of frame collision due to simultaneous transmission. Congestion is characteristic in that, the channel load shown in the examples of statistical information increases, but the reception frequency of duplicate frames does not increase because of the loss of only DATA frames due to collision.

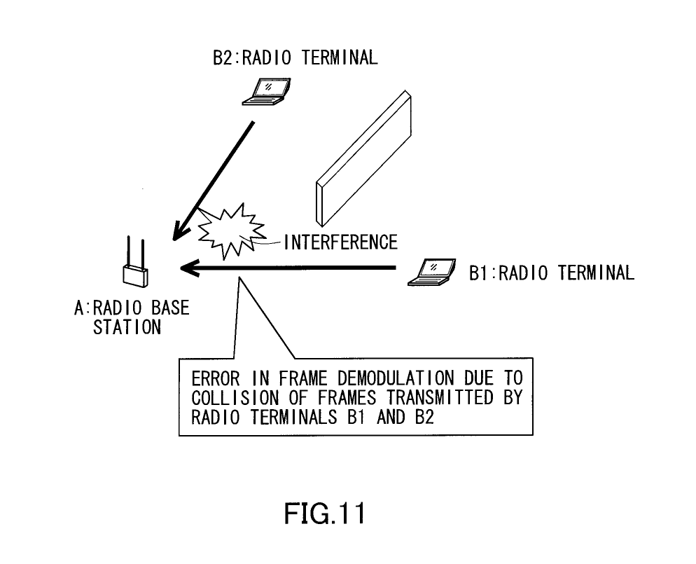

The hidden terminal in (5) indicates a state in which a shield or the like exists between radio terminals B and hence the carrier sense does not function between each other. FIG. 11 is a view showing a state in which radio terminals B1 and B2 become a hidden terminal with respect to each other. When the radio terminals B1 and B2 become hidden terminals, while the radio terminal B1 is transmitting a frame to the radio base station A, the radio terminal B2 starts transmission of a frame to the radio base station A, so that the probability of occurrence of frame collision becomes higher. The hidden terminal is characteristic in that the retransmission frequency shown in the examples of statistical information increases, but the reception frequency of duplicate frames does not increase because of the loss of only DATA frames due to collision.

The statistical information acquisition part 11 according to the second embodiment performs the same procedure as shown in the flowchart of FIG. 5.

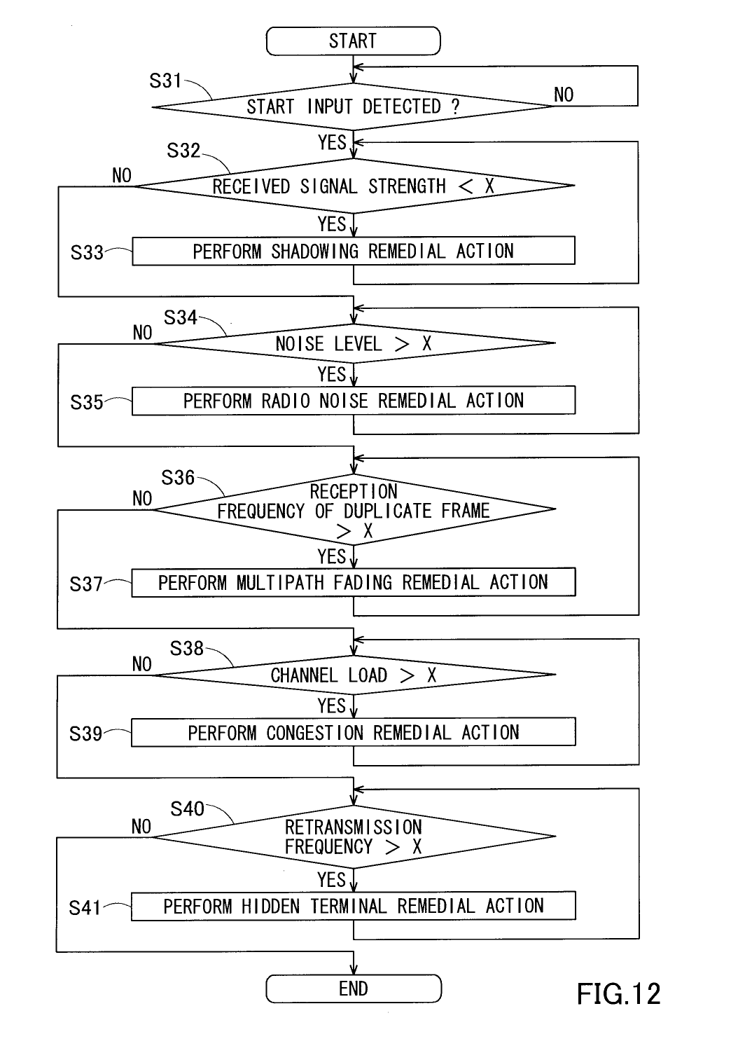

FIG. 12 is a flowchart indicating an example of the procedures of the fault detection part 13 and the remedial action execution part 14 according to the second embodiment. Steps S31 to S35 are the same as the steps S21 to S25 of FIG. 6.

When it is determined in step S34 that a noise level does not exceed a threshold level, or when the fault detection part 13 determines that a radio nose is not generated, the reception frequency of duplicate frames shown in the examples of statistical information is acquired from the statistical information storage 12 and is determined whether multipath fading occurs (step S36). The criterion is, for example, whether the reception frequency of duplicate frames exceeds a preset threshold value (such as, 50%). When the reception frequency of duplicate frames exceeds the threshold value, it is determined that multipath fading occurs.

When the fault detection part 13 determines that multipath fading occurs, the remedial action execution part 14 performs a preset remedial action procedure to eliminate multipath fading (step S37). The remedial action procedure may be any procedure for mitigating intersymbol interference that occurs in a multipath propagation channel. For example, it may be a procedure changing the modulation mode to OFDM modulation that is less prone to the intersymbol interference, a procedure for changing a transfer rate to another rate with higher error correction coding efficiency defined in the OFDM modulation, or a procedure for roaming to another base station without a multipath propagation channel. As for the remedial action procedure against multipath fading, a manual technique, such as moving the radio terminal B to a physical position with no multipath propagation channel being formed, and installing a radio wave absorber on a wall or the like that causes a reflected wave, etc. is effective. Therefore, it may be possible to adopt a countermeasure such as installing a display apparatus in the radio terminal B and displaying a detailed remedial action procedure in order to advise a user to perform the remedial action procedure.

When the remedial action execution part 14 performs the remedial action procedure, the fault detection part 13 determines again whether there is multipath fading. It is characteristic of the remedial action execution part 14 to repeatedly perform the remedial action procedure until it is determined by the fault detection part 13 that multipath fading does not occur. As for the repeated remedial action procedure, the procedure may be switched to another remedial action procedure depending on the repetition. The degree of the effectiveness of remedial action may be changed for re-execution even if the remedial action procedure is the same. For example, in the former, it may be possible to change the modulation mode to OFDM modulation and then instruct a user to shift a physical position of the radio terminal B to another position. In the latter, it may be possible to change step by step the physical position of the radio terminal B for instructing user.

When the fault detection part 13 determines that multipath fading does not occur, it acquires the channel load shown in the example of statistical information from the statistical information storage 12 and determines that congestion occurs (step S38). The criterion is, for example, whether the channel load exceeds a preset threshold value (such as, 50%). When the channel load exceeds the threshold value, it is determined that congestion occurs.

When the fault detection part 13 determines that congestion occurs, the remedial action execution part 14 performs a preset remedial action procedure to eliminate congestion (step S39). The remedial action procedure may be any procedure as long as it can restrict simultaneous transmission caused by congestion. For example, it may be possible to switch an access mode to PCF (Point Coordination Function) to eliminate competition of media access in DCF (Distributed Coordination Function) that is the cause of simultaneous transmission, to implement admission control to prevent the congestion from occurring by restricting the number of radio terminals B to be connected to the radio base station A, etc.

When the remedial action execution part 14 performs the remedial action procedure, the fault detection part 13 determines again whether there is congestion. It is characteristic of the remedial action execution part 14 to repeatedly perform the remedial action procedure until it is determined by the fault detection part 13 that congestion does not occur. As for the repeated remedial action procedure, the procedure may be switched to another remedial action procedure depending on the repetition. The degree of the effectiveness of remedial action may be changed for re-execution even if the remedial action procedure is the same. For example, in the former, it may be possible to switch the access mode to PCF and then to perform the restriction of the number of radio terminals B to be connected. In the latter, it may be possible to change step by step the number of radio terminals B to be connected.

When the fault detection part 13 determines that congestion does not occur, it acquires the retransmission frequency shown in the example of statistical information from the statistical information storage 12 and determines whether there is a hidden terminal (step S40). The criterion is, for example, whether the retransmission frequency exceeds a preset threshold value (such as, 50%). When the retransmission frequency exceeds the threshold value, it is determined that there is a hidden terminal.

When the fault detection part 13 determines that there is a hidden terminal, the remedial action execution part 14 performs a preset remedial action procedure to eliminate the hidden terminal (step S41). The remedial action procedure may be any procedure as long as it can restrict frame collision caused by a hidden terminal. For example, it may be possible to activate the RTS/CTS function defined in IEEE802.11 standard. As for the remedial action procedure against the hidden terminal, a manual technique such as moving the radio terminals B both being a hidden terminal with respect to each other to the physical positions at which mutual carrier sense is possible, is effective. Therefore, it may be possible to adopt a countermeasure such as installing a display apparatus in the radio terminal B and displaying a detailed remedial action procedure thereon in order to advise user on the execution of the remedial action procedure.

When the remedial action execution part 14 performs the remedial action procedure, the fault detection part 13 determines again whether there is a hidden terminal. It is characteristic of the remedial action execution part 14 to repeatedly perform the remedial action procedure until it is determined by the fault detection part 13 that there is no hidden terminal. As for the repeated remedial action procedure, the procedure may be switched to another remedial action procedure depending on the repetition. The degree of the effectiveness of remedial action may be changed for re-execution even if the remedial action procedure is the same. For example, in the former, it may be possible to activate the RTS/CTS function and then instruct a user to shift a physical position of the radio terminal B to another. In the latter, it may be possible to change step by step the physical position of the radio terminal B for instructing user.

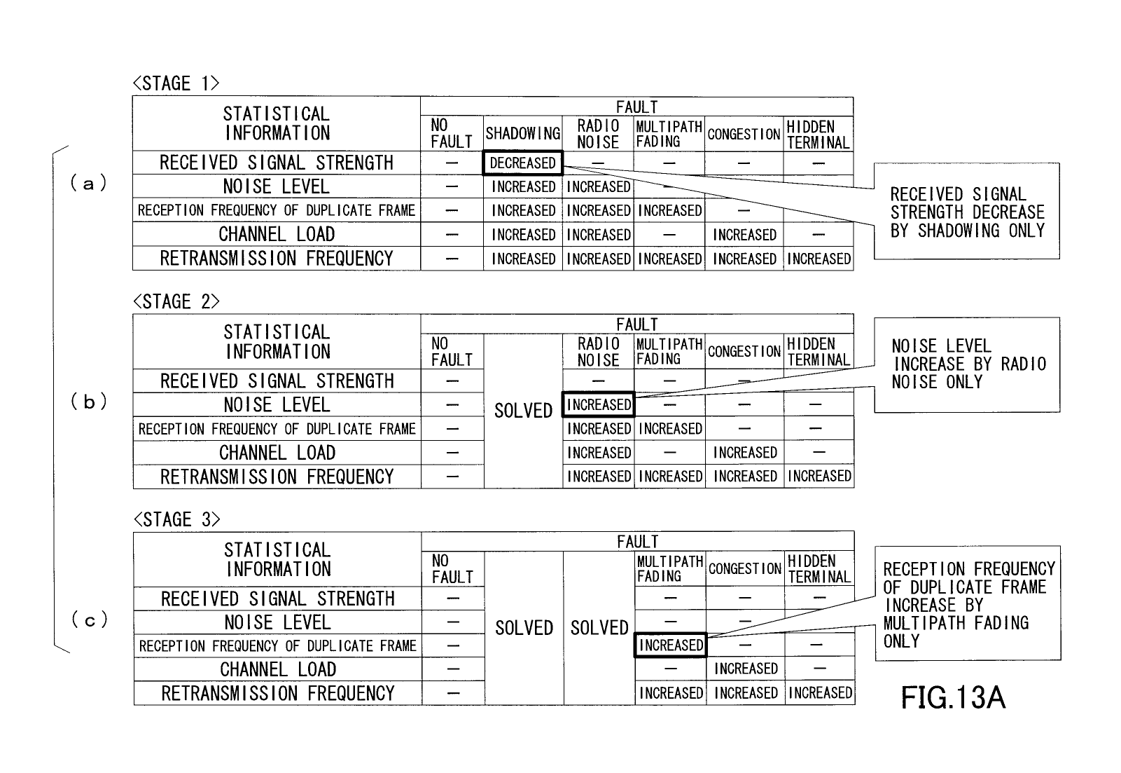

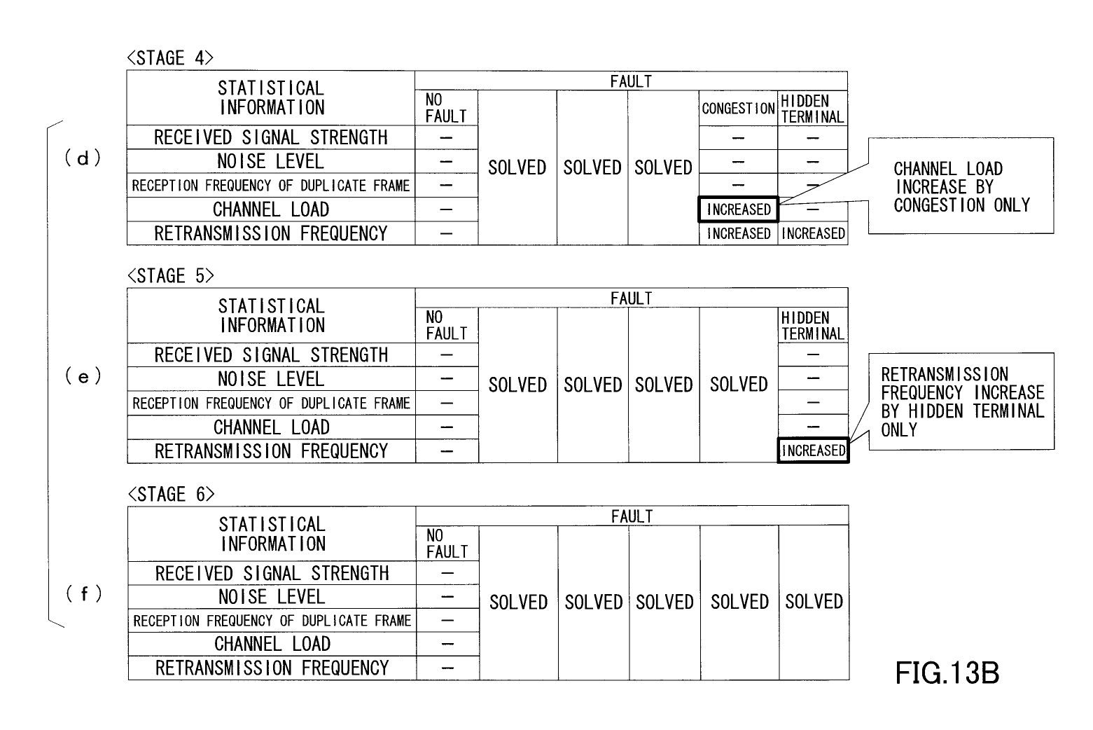

Examples concerning the procedures of fault estimation and remedial action shown in the flowchart of FIG. 12 will be explained based on the relationship between statistical information and faults. FIGS. 13A and 13B are views showing examples of the relationship between statistical information and faults, and the procedures of fault estimation and remedial action. FIGS. 13A and 13B show how the characteristic values of statistical information vary per fault.

For example, the received signal strength is indicated by “decreased” or “-”, and the noise frame, reception frequency of duplicate frames, channel load, and retransmission frequency are indicated by “increased” or “-”.

As understood from FIGS. 13A and 13B, although the faults and characteristic values of statistical information correspond to each other, there are cases in which the characteristic values of a plurality of types of statistical information correspond to the same fault. It is therefore impossible to identify a fault by the type of statistical information only.

Accordingly, in this embodiment, a remedial action is taken against a fault by prioritizing a plurality of types of statistical information so that a fault can be identified and examined the characteristic values of statistical information one by one.

In a stage 1 shown in FIG. 13A(a), the procedures corresponding to the steps S32 and S33 of FIG. 12 are performed. As understood from FIG. 13A(a), the received signal strength is the statistical information having a correlation with shadowing only in a plurality of types of faults. Therefore, taking a remedial action so that the received signal strength does not become lower than a predetermined threshold value is equivalent to taking a remedial action against shadowing. Therefore, by taking a remedial action against shadowing, the received signal strength becomes higher than the predetermined threshold value, and hence the problem of shadowing is solved.

Next, in a stage 2 shown in FIG. 13A(b), the procedures corresponding to the steps S34 and S35 of FIG. 12 are performed. As understood from FIG. 13A(b), the noise level is the statistical information having a correlation with the radio noise only in a plurality of types of faults. Therefore, taking a remedial action so that the noise level does not exceed a predetermined threshold value is equivalent to taking a remedial action against the radio noise. Therefore, by taking a remedial action against the radio noise, the noise level becomes lower than the predetermined threshold level, and hence the problem of radio noise is solved.

Next, in a stage 3 shown in FIG. 13A(c), the procedures corresponding to the steps S36 and S37 of FIG. 12 are performed. As understood from FIG. 13A(c), the reception frequency of duplicate frames is the statistical information having a correlation with multipath fading only in a plurality of types of faults. Therefore, taking a remedial action so that the reception frequency of duplicate frames does not exceed a predetermined threshold value is equivalent to taking a remedial action against multipath fading. Therefore, by taking a remedial action against multipath fading, the reception frequency of duplicate frames becomes lower than the predetermined threshold value, and hence the problem of multipath fading is solved.

Next, in a stage 4 shown in FIG. 13B(d), the procedures corresponding to the steps S38 and S39 of FIG. 12 are performed. As understood from FIG. 13B(d), the channel load is the statistical information having a correlation with congestion only in a plurality of types of faults. Therefore, taking a remedial action so that the channel load does not exceed a predetermined threshold value is equivalent to taking a remedial action against congestion. Therefore, by taking a remedial action against congestion, the channel load becomes lower than the predetermined threshold value, and hence the problem of congestion is solved.

Next, in a stage 5 shown in FIG. 13B(e), the procedures corresponding to the steps S40 and S41 of FIG. 12 are performed. As understood from FIG. 13B(e), the retransmission frequency is the statistical information having a correlation with the hidden terminal only in a plurality of types of faults. Therefore, taking a remedial action so that the retransmission frequency does not exceed a predetermined threshold value is equivalent to taking a remedial action against the hidden terminal. Therefore, by taking a remedial action against the hidden terminal, the retransmission frequency becomes lower than the predetermined threshold value, and hence the problem of retransmission is solved. Through the stage 5, as shown in a stage 6 of FIG. 13B(f), every fault is eliminated.

Accordingly, in the second embodiment, faults can be eliminated by the minimum number of steps by examining the characteristic values of statistical information each having a one-to-one correspondence with one fault and taking the remedial actions against the respective faults one by one, even if a lager number of types of faults than the first embodiment occur together.

### Third Embodiment

In a third embodiment, a traffic demand available for fault detection is transmitted from a radio apparatus M to another radio station.

Fault estimation uses statistical information that varies in accordance with the transmission and reception of radio traffic. When traffic is little, change in statistical information is also little, and hence it may happen that the estimation accuracy is lowered, or the time to reach a threshold value is made longer.

The radio traffic includes parameters such as transmission power, payload length and transfer rate. The parameters may affect the degree of change in statistical information, and hence have to be taken into consideration. In the third embodiment to be explained below, the parameters of radio traffic suitable for fault estimation will be explained, concerning each piece of the statistical information discussed in the first embodiment.

The received signal strength is the statistical information that reflects the signal strength of radio frames successfully received. Therefore, statistical samples of the received signal strength can be efficiently collected by transmitting a radio frame that tends to be successfully received to a communications partner. The radio frame that tends to be successfully received is, for example, a frame with a low transfer rate (a low bit error rate), a small frame length (a low frame error rate), and a large transmission power (a high SN ratio).

The reception frequency of duplicate frames is the statistical information that increases when (1) a data frame is successfully received, (2) an ACK frame corresponding to the data frame is lost, and then (3) the data frame is retransmitted. Therefore, the loss of an ACK frame can be efficiently detected by transmitting a radio frame that tends to be successfully received to a communications partner. The radio frame that tends to be successfully received, in this case, is the same as the radio frame in the case of the received signal strength.

The retransmission frequency is the statistical information that increases at a transmission side when (1) a data frame is transmitted, (2) an ACK frame corresponding to the data frame cannot be acquired, and then (3) the data frame is retransmitted. It is preferable to adjust the threshold value for determination of retransmission frequency, taking into consideration the parameters of a transmitted radio frame.

The noise level and channel load are the statistical information for which the surrounding radio-wave condition is measured. Therefore, the transmission and reception of radio frames may not be conducted by a radio terminal B that performs fault estimation. Or, the parameters of radio frames to be transmitted and received may be acquired and the effects of the parameters may be taken into account.

The parameters of radio traffic suitable for fault estimation using statistical information have been explained above. Shown in the following is an example in which the radio terminal B requests the radio base station A for a traffic suitable for fault estimation.

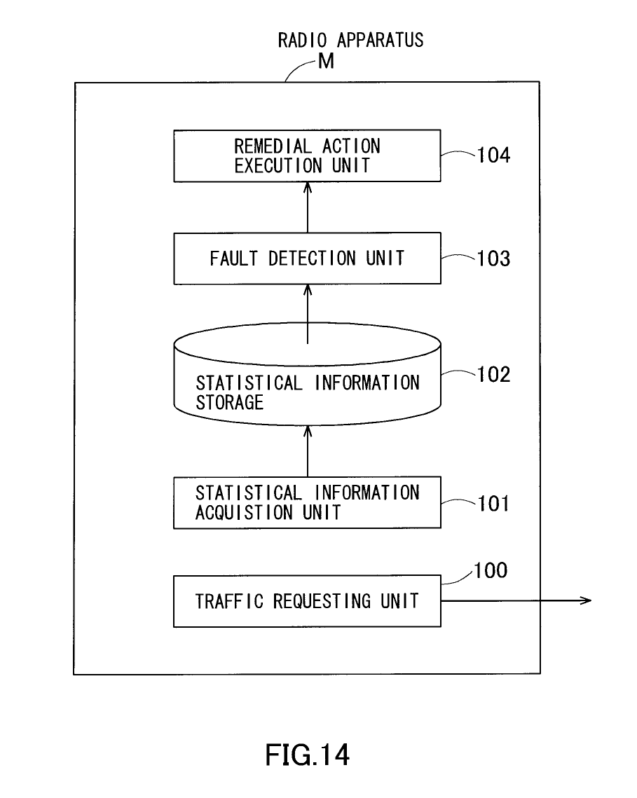

FIG. 14 is a block diagram showing an example of the internal structure of a radio apparatus M according to the third embodiment. The radio apparatus M of FIG. 14 has a statistical information acquisition part 101, a statistical information storage 102, a fault detection part 103, and a remedial action execution part 104, like shown in FIG. 2, and, in addition, a traffic requesting part 100 for transmitting a traffic request to a communications partner.

Like the first and second embodiments, the radio apparatus M of FIG. 14 is installed in either of the radio base station A and the radio terminal B.

The traffic requesting part 100 periodically transmits a traffic request to another radio station (the radio base station A or the radio terminal B). Or, it transmits a traffic request in a case where statistical information meets a specific condition such as the retransmission frequency at the radio terminal B exceeds a predetermined threshold value, in a case where there is an instruction from a user, or at least the two cases occur.

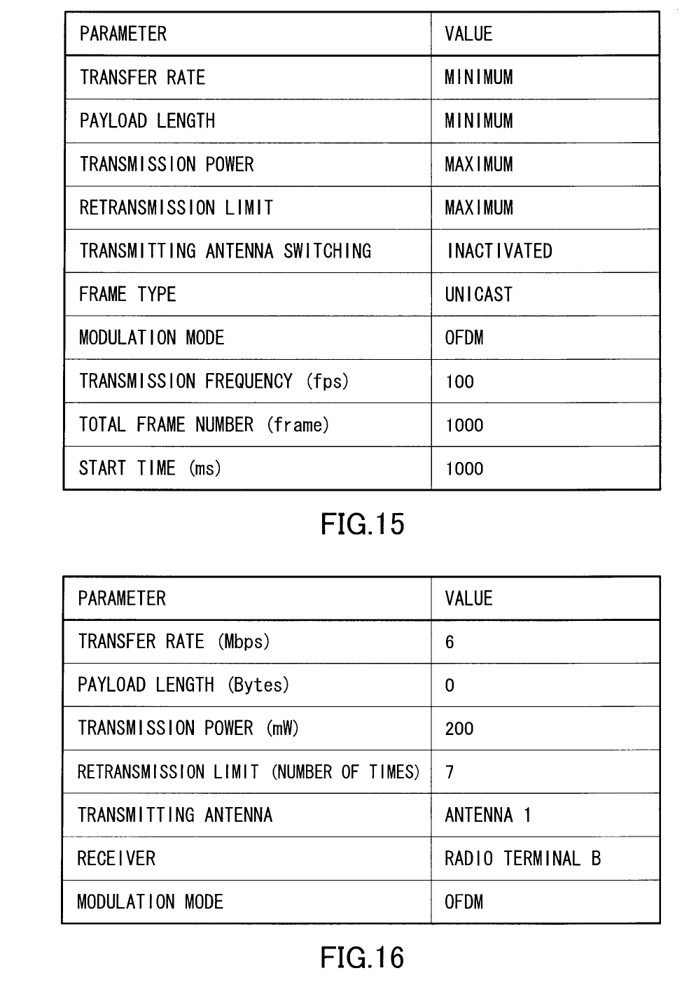

FIG. 15 is a view showing examples of traffic parameters included in a traffic request. The traffic request includes at least one of the parameters shown in FIG. 15. Each parameter may be a specific numerical value or an indicator indicating the degree such as “maximum” and “minimum”.

A radio station that has received a traffic request (referred to as the radio base station A, hereinafter) sets a parameter included in the traffic request to a specified value to create traffic towards the radio apparatus M (referred to as the radio terminal B, hereinafter). For example, the radio base station A that has received a traffic request including all of the parameters of FIG. 15 waits for one second and then transmits radio frames having parameters shown in FIG. 16 for 10 seconds at 100 fps in transmission frequency, 100 frames in total.

The traffic requesting part 100 and the statistical information acquisition part 101 may operate asynchronously. A synchronous procedure may, however, be performed in such a manner that the traffic requesting part 100 informs the statistical information acquisition part 101 of traffic start and completion to make a statistical-information acquisition interval during a traffic generation period shorter than a normal interval. The timing of traffic completion may be the time indicated by a parameter of a traffic request or the time at which an excess of a traffic amount is detected. Or, the traffic completion may be informed by transmitting a traffic halt request to the radio base station A.

The example explained above is that a traffic request is transmitted with traffic parameters suitable for fault estimation. The traffic parameters may, however, not be included in a traffic request when the radio base station A has previously acquired suitable parameters in such a case that the radio terminal B has previously informed the radio base station A of the traffic parameters.

As described above, according to the third embodiment, in addition to the first embodiment, a traffic request suitable for fault estimation is transmitted from the radio terminal B to the radio base station A. Therefore, higher estimation accuracy than the first embodiment is achieved and also shorter estimation time is achieved.

At least part of the radio apparatus and the radio communication system explained in the above embodiments may be configured with hardware or software. When it is configured with software, a program that achieves the function of at least part of the radio apparatus and the radio communication system may be stored in a storage medium such as a flexible disk and CD-ROM, and installed in and executed by a computer. The storage medium may not only be detachable type such as a magnetic disk and an optical disk but also a fixed type such as a hard disk drive and a memory.

Moreover, a program that achieves the function of at least part of the radio apparatus and the radio communication system may be distributed via a communication network (including wireless communication) such as the Internet. The program may also be distributed via an online network such as the Internet or a wireless network, or stored in a storage medium and distributed under the condition that the program is encoded, modulated or compressed.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A radio apparatus configured to identify a fault of a radio link with a radio station and to execute a remedial action, comprising:
a statistical information acquisition part configured to acquire a characteristic value of statistical information expressing a status of the radio link;
a fault detector configured to detect a plurality of faults preliminarily associated with the statistical information in a predetermined order based on the characteristic value; and
a remedial action execution part configured to execute a remedial action preliminarily associated with the fault detected by the fault detector;
wherein the plurality of faults comprises a shadowing and a radio noise; and
the predetermined order is set so that a detection of the shadowing has priority over a detection of the radio noise.

2. The apparatus of claim 1, wherein the statistical information comprises information regarding a received signal strength;
the fault detector is configured to detect whether or not the received signal strength exceeds a first threshold value; and
the remedial action execution part is configured to execute the remedial action for reducing the shadowing until the received signal strength exceeds the first threshold value.

3. The apparatus of claim 2, wherein the statistical information comprises information regarding a noise level;
the fault detector is configured to detect whether or not the noise level is below the second threshold value, after the received signal strength exceeds the first threshold value; and
the remedial action execution part is configured to execute the remedial action for reducing the radio noise until the noise level is below the second threshold value.

4. The apparatus of claim 3, wherein the fault detector detects whether or not the characteristic value of predetermined statistical information except for the received signal strength and the noise level is within a predetermined range, after the noise level is below the second threshold value; and
the remedial action execution part is configured to execute the remedial action for cancel out a cause of the fault except for the shadowing and the radio noise in the predetermined order until the characteristic value of predetermined statistical information becomes within a predetermined range.

5. The apparatus of claim 1, wherein the plurality of faults comprise a multipath fading, a congestion and a hidden terminal; and
the predetermined order is set so that it is detected whether or not the shadowing is present, and then whether or not the radio noise is present, and then whether or not the multipath fading, the congestion and the hidden terminal are present, respectively, in a predetermined order.

6. The apparatus of claim 3, wherein the statistical information comprises information regarding a reception frequency of duplicate frames;
the plurality of faults comprise the multipath fading;
the fault detector is configured to detect whether the reception frequency of the duplicate frames is below a third threshold value, after the noise level is below the second threshold value; and
the remedial action execution part is configured to execute the remedial action for reducing the multipath fading until the reception frequency of the duplicate frames is below the third threshold value.

7. The apparatus of claim 3, wherein the statistical information comprises information regarding a channel load;
the plurality of faults comprises a congestion;
the fault detector is configured to detect whether the channel load is below a fourth threshold value, after the noise level exceeds the second threshold value; and
the remedial action execution part is configured to execute the remedial action for reducing the congestion until the channel load is below the fourth threshold value.

8. The apparatus of claim 3, wherein the statistical information comprises information regarding a retransmission frequency;
the plurality of faults comprise a hidden terminal;
the fault detector is configured to detect whether the retransmission frequency is below a fifth threshold value, after the noise level exceeds the second threshold value; and
the remedial action execution part is configured to execute the remedial action against the hidden terminal until the retransmission frequency is below the fifth threshold value.

9. The apparatus of claim 1, further comprising a traffic request part configured to transmit a traffic request used for detection of the plurality of faults,
wherein the traffic request comprises at least one of a transfer rate, a payload length and a transmission power.

10. The apparatus of claim 9, wherein the traffic request comprises a maximum value and a minimum value of at least one of the transmission rate, the payload length and the transmission power.

11. A method for communication disturbance remedial action which identifies a fault of a radio link between a radio apparatus and a radio station and executes a remedial action, comprising:
acquiring a characteristic value of statistical information expressing a status of the radio link;
detecting a plurality of faults preliminarily associated with the statistical information in a predetermined order based on the characteristic value; and
executing a remedial action preliminarily associated with the fault detected by the fault detector;
wherein the plurality of faults comprises a shadowing and a radio noise; and
the predetermined order is set so that a detection of the shadowing has priority over a detection of the radio noise.

12. The method of claim 11, wherein the statistical information comprises information regarding a received signal strength;
the fault detector is configured to detect whether or not the received signal strength exceeds a first threshold value; and
the remedial action execution part is configured to execute the remedial action for reducing the shadowing until the received signal strength exceeds the first threshold value.

13. The method of claim 12, wherein the statistical information comprises information regarding a noise level;
the fault detector is configured to detect whether or not the noise level is below the second threshold value, after the received signal strength exceeds the first threshold value; and
the remedial action execution part is configured to execute the remedial action for reducing the radio noise until the noise level is below the second threshold value.

14. The method of claim 13, wherein the fault detector detects whether or not the characteristic value of predetermined statistical information except for the received signal strength and the noise level is within a predetermined range, after the noise level is below the second threshold value; and
the remedial action execution part is configured to execute the remedial action for cancel out a cause of the fault except for the shadowing and the radio noise in the predetermined order until the characteristic value of predetermined statistical information becomes within a predetermined range.

15. The method of claim 11, wherein the plurality of faults comprise a multipath fading, a congestion and a hidden terminal; and
the predetermined order is set so that it is detected whether or not the shadowing is present, and then whether or not the radio noise is present, and then whether or not the multipath fading, the congestion and the hidden terminal are present, respectively, in a predetermined order.

16. A computer-readable storage medium which stores a program causing a computer to make communication disturbance remedial action which identifies a fault of a radio link between a radio apparatus and a radio station and executes a remedial action, the program comprising:
acquiring a characteristic value of statistical information expressing a status of the radio link;
detecting a plurality of faults preliminarily associated with the statistical information in a predetermined order based on the characteristic value; and
executing a remedial action preliminarily associated with the fault detected by the fault detector;
wherein the plurality of faults comprises a shadowing and a radio noise; and
the predetermined order is set so that a detection of the shadowing has priority over a detection of the radio noise.

17. A medium for communication disturbance remedial action which identifies a fault of a radio link between a radio apparatus and a radio station and executes a remedial action, comprising:
acquiring a characteristic value of statistical information expressing a status of the radio link;
detecting a plurality of faults preliminarily associated with the statistical information in a predetermined order based on the characteristic value; and
executing a remedial action preliminarily associated with the fault detected by the fault detector;
wherein the plurality of faults comprises a shadowing and a radio noise; and
the predetermined order is set so that a detection of the shadowing has priority over a detection of the radio noise.

18. The medium of claim 17, wherein the statistical information comprises information regarding a received signal strength;
the fault detector is configured to detect whether or not the received signal strength exceeds a first threshold value; and
the remedial action execution part is configured to execute the remedial action for reducing the shadowing until the received signal strength exceeds the first threshold value.

19. The medium of claim 18, wherein the statistical information comprises information regarding a noise level;
the fault detector is configured to detect whether or not the noise level is below the second threshold value, after the received signal strength exceeds the first threshold value; and
the remedial action execution part is configured to execute the remedial action for reducing the radio noise until the noise level is below the second threshold value.

20. The medium of claim 19, wherein the fault detector detects whether or not the characteristic value of predetermined statistical information except for the received signal strength and the noise level is within a predetermined range, after the noise level is below the second threshold value; and
the remedial action execution part is configured to execute the remedial action for cancel out a cause of the fault except for the shadowing and the radio noise in the predetermined order until the characteristic value of predetermined statistical information becomes within a predetermined range.
